(19) United States
(12) Patent Application Publication
(10) Pub. No.: US 2014/0136280 A1
(43) Pub. Date: May 15, 2014

(54) Predictive Tool Utilizing Correlations With Unmeasured Factors Influencing Observed Marketing Activities

(71) Applicant: ADOBE SYSTEMS INCORPORATED, San Jose, CA (US)

(72) Inventors: Ayman Omar Farahat, San Francisco, CA (US); Nesreen Kamel Abuseree Ahmed, West Lafayette, IN (US)

(73) Assignee: Adobe Systems Incorporated, San Jose, CA (US)

(21) Appl. No.: 13/678,149

(22) Filed: Nov. 15, 2012

(51) Int. Cl. G06Q 30/02

(52) U.S. Cl. CPC G06Q 30/0202
USPC 705/7.31

(57) ABSTRACT

Methods and apparatus for a predictive tool utilizing correlations with unmeasured factors influencing marketing activities are described. A method comprises determining a set of measurable factors with which decisions to perform a type of marketing activity are correlated, and a set of measurable factors with which a category of entity results is correlated. The method includes generating, using the sets of measurable factors, a model configured to predict probabilities of results of the category of results. The prediction is based on a correlation determined between unmeasured factors represented in the model as influencing the category of results, and one or more unmeasured factors represented in the model as influencing decisions on implementing the type of marketing activity. The method comprises using the model to predict the probability of a particular entity result.

### BACKGROUND

In recent years, the use of various types of online marketing campaigns, such as discounts or coupons provided via e-mail and/or web sites to sets of potential customers, has grown rapidly. Some facilitators of such marketing activities may send out thousands of coupons every day in dozens of cities on behalf of hundreds of service providers, product manufacturers, retailers and other businesses. In some cases, it may be possible to collect information programmatically about the marketing campaigns being run by various types of entities, including for example how often a particular entity implements such campaigns, the sizes of the discounts offered, and so on.

Various types of online sources also provide data about the business environment as a whole. A number of formal sources of business data, such as databases maintained by governmental agencies, directories of local businesses managed by various chambers of commerce, business periodicals and the like, may provide information about the relative success or failure of different business entities, some of which may be employing various types of online marketing activities. As social media usage expands, the amount of informal (e.g., customer-generated) data available regarding customer perceptions of quality, as well as successes and failures of entities that implement various marketing activities, has also risen correspondingly. Although some measures of the success or failure of particular marketing activities may be relatively easy to identify—for example, a specific coupon offer may be considered a success if a targeted number of coupons is sold before a deadline—the overall impact over time of such marketing activities on the businesses that engage in them may be harder to evaluate.

### SUMMARY

Various embodiments of methods and apparatus for a predictive tool that utilizes correlations with unmeasured factors influencing observed marketing activities are described. According to one embodiment, a computer-implemented method may include determining a first set of measurable factors with which decisions to perform a type of marketing activity are correlated, and a second set of measurable factors with which a category of entity results is correlated. The method may include generating, using at least in part the first and second sets of measurable factors, a model configured to predict a respective probability of one or more results of the category of entity results. The prediction may be based at least in part on a correlation determined between one or more unmeasured factors represented in the model as influencing the category of entity results, and one or more unmeasured factors represented in the model as influencing decisions on implementing the type of marketing activity. The method may comprise predicting, using the model, the probability of a particular result of the category of results for a particular entity.

### BRIEF DESCRIPTION OF THE DRAWINGS

FIG. 1 illustrates an example system environment, according to at least some embodiments.

FIG. 2 illustrates example subcomponents of an entity result predictor, according to at least some embodiments.

FIG. 3 illustrates examples of predictor-collected data associated with a plurality of entities that implemented one or more marketing activities, according to at least some embodiments.

FIG. 4 illustrates examples of predictor-collected data associated with different types of results achieved by a plurality of entities, according to at least some embodiments.

FIG. 5 illustrates an example set of equations in which entity results and decisions to perform marketing activities are represented as dependent variables, according to at least some embodiments.

FIG. 6 is a flow diagram illustrating aspects of the operation of a predictor configured to generate entity result predictions using a model, according to at least some embodiments.

FIG. 7 illustrates an example computing device that may be used in some embodiments.

### DETAILED DESCRIPTION OF EMBODIMENTS

Various embodiments of methods and apparatus for a predictive tool that utilizes correlations with unmeasured factors influencing observed marketing activities are described. According to some embodiments, such a predictive tool, which may be termed a “predictor” herein, may determine a first set of measurable factors with which decisions by various entities to implement a type of marketing activity (such as offers of online or offline discounts or coupons) are correlated, and a second set of measurable factors with which a category of entity results (such as the survival or closure of entities, growth in entity sales or entity revenue) is correlated. The two sets of measurable factors may, for example, be based on business data collectable programmatically from one or more data sources over the Internet or other networks. The predictor may generate a model that can predict a probability of one or more results of the category of entity results, based for example on the occurrence of a marketing activity. In some embodiments, the model may include variables representing the measurable factors, and error terms representing unmeasured factors that may influence the decisions to perform the marketing activities, or unmeasured factors that may influence the entity results. The prediction may be based at least in part on a correlation determined between one or more unmeasured factors represented in the model as influencing the category of entity results, and one or more unmeasured factors represented in the model as influencing decisions on implementing the type of marketing activity. The predictor may use the model to predict a probability of a particular result for a particular entity.

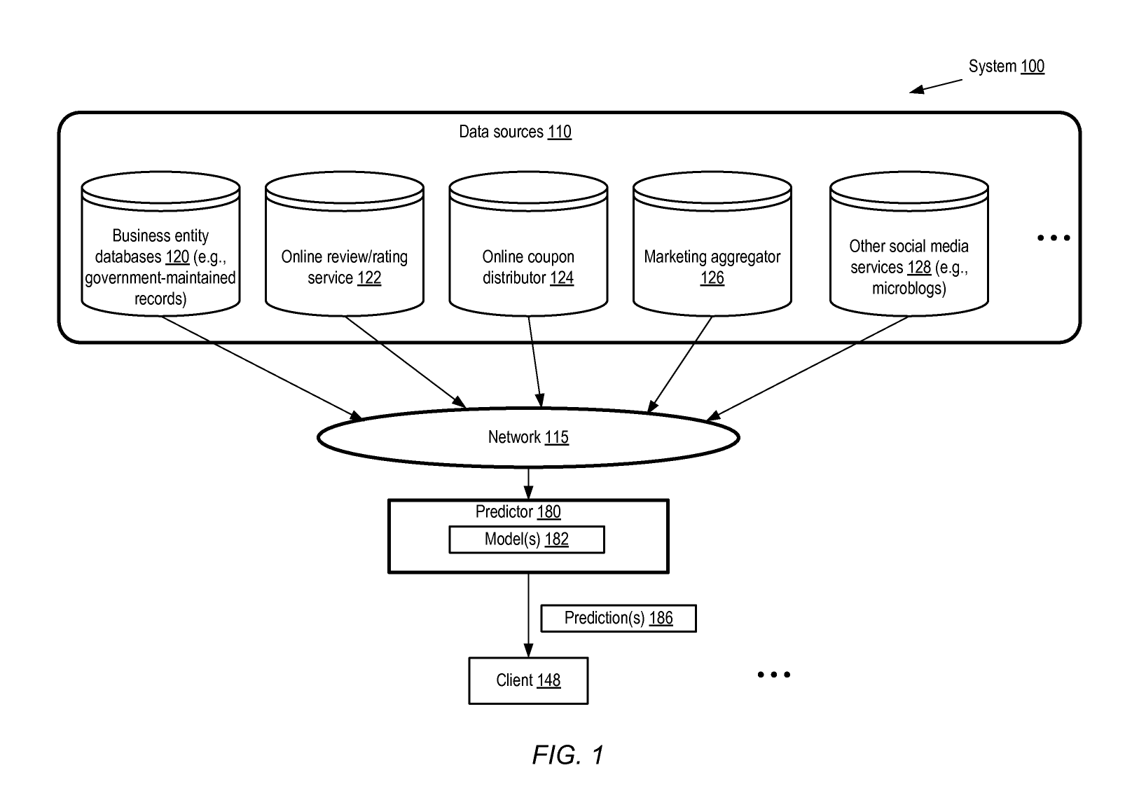

FIG. 1 illustrates an example system environment, according to at least some embodiments. As shown, system 100 may include a plurality of data sources 110, from which a predictor 180 may collect data via a network 115 (such as the Internet or any other public or private network) regarding various types of marketing activities performed by different entities, and regarding business results or outcomes of the entities. The collected data may include a variety of structured and/or unstructured fields, and the predictor 180 may analyze the data and classify various elements of the data into domain-specific subsets in some embodiments—e.g., one set of data may be classified as being associated with restaurants, another set may be associated with hotels, and so on. The data may be partitioned along a plurality of dimensions in some embodiments by the predictor—e.g., based on geographical location of the entities, or based on relative sizes of the entities. The services provided by the predictor 180 in the depicted embodiment may be based on a set of assumptions regarding the factors that influence entity decisions and/or entity results: including, for example, (a) that while data regarding numerous aspects of entity operations, such as when decisions to employ specific types of marketing activities were made, or how positively an entity is rated by its customers, may be obtained or measured fairly precisely, there may often be significant unmeasured or unknown factors that influence various entity decisions and results; and (b) that at least some of the unmeasured factors may be related, in that, for example, unmeasured factors that led to the implementation of an online coupon campaign by an entity may also influence, or at least be correlated with, wider aspects of the entity's success or failure.

Accordingly, predictor 180 may use the collected data to formulate one or more models 182 that are intended to represent factors influencing entity decisions and results in the depicted embodiment. In at least some models 182, the relative influences of measurable factors (e.g., factors about which specific data points can be collected or calculated from the data sources 110) affecting the decisions to perform the marketing activities, and the relative influences of measurable factors influencing various types of entity results, may be represented using independent variables. The models 182 may represent the decisions regarding marketing activities, and the entity results, as dependent variables that are affected by or correlated with respective sets of independent variables representing the measurable factors. In addition to the measurable factors, the models 182 may also include error terms representing unmeasured or unknown factors influencing (or correlated with) the marketing activity decisions or the entity results in some embodiments. The models 182 may comprise various types of regression equations in different embodiments. Such equations may be solved, e.g., the coefficients of the modeled independent variables in the equations may be determined, using at least some of the collected data in some embodiments. A determination may be made as to whether, for a given category of results and a given type of marketing activity, the two error terms —one representing unmeasured factors influencing marketing activity decisions, and the other representing unmeasured factors influencing the category of entity results—are themselves correlated. If a statistically significant correlation is found, the predictor 180 may infer that the occurrences of the marketing activities can be used with some confidence level to predict the probability of the entity results. Accordingly, in the depicted embodiment, the predictor 180 may be able to generate predictions 186 for a client 148 using the model, such as a prediction that there is an X % chance of a particular business result if a marketing activity of a specific type is implemented by an entity. A time period within which the result is expected may also be provided to a client 148 of the predictor 180 in some embodiments. Different clients 148 may submit respective prediction requests in some embodiments, e.g., a particular client may submit requests about the prospects of revenue decrease or increase of one of its competitors. In response to such a query, the predictor 180 may determine whether it can provide a useful prediction, based for example on the types of data it has collected, or on the types of models that it has generated or can generate. If a prediction with a reasonable confidence level can be generated, the predictor may provide such a prediction; otherwise, at least in some embodiments, the predictor may indicate that it has insufficient information to make a prediction.

According to one embodiment, if the predictor finds a correlation between the error terms representing unmeasured factors using a particular modeling approach or methodology, an additional modeling technique may be used to increase the confidence in the predictions. If two independent modeling methodologies confirm that there is significant correlation between the error terms, even if the precise numerical value associated with the correlation differs somewhat, the chances that the correlation arose due to a methodological error or a programming error may be considered low. For example, if a covariance value of 0.4 is found between the two error terms using one methodology, and a different methodology also yields a significant covariance value of 0.3, the hypothesis that the unmeasured factors are related may be confirmed with a higher degree of confidence than if just one methodology were used. A variety of different modeling methodologies may be used in different embodiments, either for the initial determination of the correlation, or for the confirmation—e.g., a probit model may be used, a SURE (seemingly unrelated regression equations) framework or model may be used, or some other modeling approach may be used.

In at least some embodiments, the data sources 110 may include business databases 120 maintained by government agencies such as city governments, county governments, state governments and the like, from which information about the types of products or services a particular entity provided, the locations of the entities (where their business is conducted), their numbers of employees, and the like may be obtained. For some entities which may be incorporated as public companies, data on revenues, profits and the like may also be available, e.g., from regulatory government agencies such as the Securities and Exchange Commission in the United States. Entity results of various types may also be retrieved from business groups such as chambers of commerce or trade associations in some embodiments. Informal or unofficial information regarding various aspects of different business entities, including their popularity or user-generated ratings, when they opened and closed, and the like, may also be retrieved from online review or rating services 122 in some embodiments, or from other social media platforms 128 such as blogs or micro-blogs. Data about marketing campaigns or activities performed by various entities may be obtained from sources such as online coupon distributors 124, other platforms or services that facilitate various types of marketing activities, or marketing promotion aggregators 126 (e.g., businesses that collect offers such as coupons or discount codes from a variety of vendors and offer them to potential customers from a common platform), and also in some cases from online review services 122 or social media services 128.

Any combination of a number of different techniques may be used to retrieve the data from the sources 110 in various embodiments. Some data sources 110 may support application programming interfaces (APIs), search interfaces or query interfaces allowing retrieval of the data in one embodiment, either for a payment or without a payment. In some embodiments, the predictor 180 may employ web-scraping tools or screen-scraping tools to extract the data from web pages maintained by one or more data sources 110. Some data source may publish their data in the form of downloadable documents or reports that may be obtained by the predictor 180 in at least some embodiments.

The predictor 180 may enable interactions with clients 148 via one or more programmatic interfaces in some embodiments, such as web pages, APIs, or installable client-side programs that implement one or more graphical user interfaces (GUIs). Using such interfaces, clients 148 may in some embodiments submit queries regarding entity results, such as queries logically equivalent to “How likely is it that my competitor, entity Y, which offered 3 online coupons in the last month, will go out of business within the next year?” or “Is it likely that entity Z, which stopped offering online coupons a month ago, will open a new branch in the next 6 months?”. Depending on the collected data and the models 182 in a given implementation, the predictor may be able to make the requested predictions in some cases; in other cases, there may be insufficient correlation (or insufficient source data) to make predictions with a reasonable level of confidence, and the predictor may respond to the query by indicating that there is insufficient data for the requested prediction. In at least some embodiments, the predictor's functionality may be offered as a service to which interested clients may subscribe. In one embodiment, the predictor 180 may generate periodic reports containing predictions made on the basis of the model(s) 182 regarding entities in one or more business domains, without requiring clients 148 to submit specific queries.

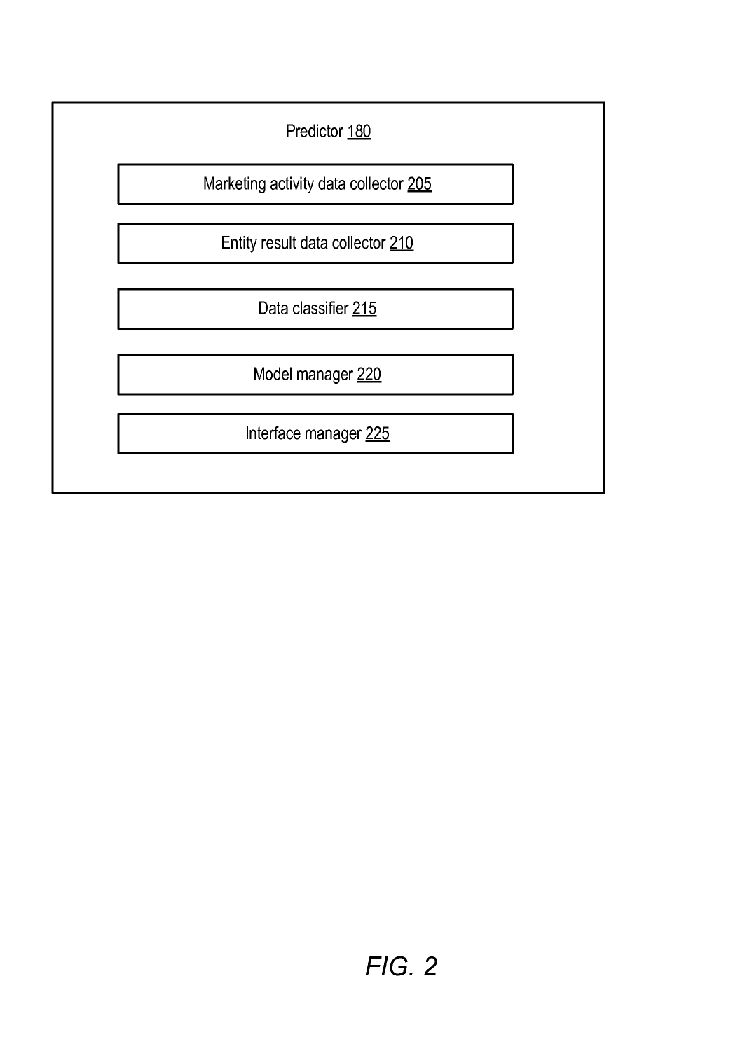

FIG. 2 illustrates example subcomponents of an entity result predictor 180, according to at least some embodiments. In the illustrated embodiment, the predictor 180 may comprise five subcomponents or modules: a marketing activity data collector 205, an entity result data collector 210, a data classifier 215, a model manager 220, and an interface manager 225. The marketing activity data collector 205 may be configured to use any appropriate programmatic interface to collect data from one or more of the data sources 110 about various types of marketing activities performed by business entities of interest in the depicted embodiment. For example, a web site of a marketing aggregator 126 may be examined using a screen-scraping script or tool to obtain marketing activity information, or APIs supported by an online coupon distributor 124 may be used to determine which entities offered online coupons during a given time period. Similarly, entity result data collector 210 may retrieve information programmatically about business establishment, closure, expansion and the like from a variety of data sources 110 such as government agency databases, business group databases and the like, as well as from online review/rating services 122 or other social media sites 128. In at least some cases a given data source 110 may provide information about entity results as well as marketing activities—for example, user-generated reviews may include mentions of marketing activities such as online coupons, as well as entity results such as closures, user-provided star ratings and the like.

In the depicted embodiment, data classifier 215 may be configured to analyze the collected data, parsing portions of it if necessary, and arranging the collected data into hierarchies or subsets, such as domain-specific subsets. For example, in one implementation, information gathered about marketing activities as well as business results may be partitioned into respective subsets associated with the following domains of business endeavor: “restaurants and bars”, “shopping”, “food”, “beauty and spas”, “health and medical”, “nightlife”, “active life”, “arts and entertainment”, “hair salons”, “fitness and recreation”. In addition to classifying the data based on the type of service or product being provided by the entities, data classifier 215 may also organize the data along other dimensions in some embodiments. The data may be partitioned based on effective time periods (e.g., data gathered at a data source for the January-March quarter of a given year may be separated from data gathered for the May-June quarter), size of entity (based on revenues, profits, sales, or number of employees), product price range, service price range, geographical location of the entity (e.g., country, state, city, county, neighborhood, or postal code), customer satisfaction levels (e.g., based on “star” ratings in user-generated reviews), customer feedback quantity (e.g., based on the number of reviews generated by users for the entity), or other characteristics in various embodiments. In some embodiments, unstructured data collected from one or more of the data sources 110 may be analyzed (e.g., using various natural language processing techniques) by the data classifier 215 to help with the classification.

The model manager 220 may be responsible for using the data, as categorized by the data classifier 215, to generate one or more models 182 that may be used for predicting entity results in the depicted embodiment. In at least some embodiments, as mentioned earlier, one or more regression models may be generated, in which the decision to implement a particular type of marketing activity such as online coupons may be represented as one dependent variable, and a particular type of entity outcome (such as a failure or closing of an entity) may be represented as another dependent variable. Each dependent variable may be modeled as being influenced by (and therefore correlated with) a set of independent variables representing measurable or measured factors. A subset of the data obtained, calculated or deduced from data sources 110 may be used for representing a particular independent variable—e.g., the percentage of businesses that failed in a given postal code may represent a measurable factor that may be assumed to influence the probability of an entity failure in that same postal code. Other examples of measurable factors in a given model in which the occurrence of entity closure is one of the dependent variables may include the percentage of failed entities in the same product price category or service price category, average customer satisfaction rating, the number of user-generated reviews, the duration for which the entity has existed, the percentage of entities that implemented a particular marketing activity and also failed, and so on. Measurable factors that may influence entity expansion or success (e.g., an increase in revenue) may, for example, include the rate at which the economy as a whole grew in the region or city, or the change in population within a certain demographic category most likely to use the services of the entity.

In addition to representing the measurable factors as independent variables, the model may also include error terms representing unmeasured factors—e.g., the morale of employees, or the financial state of the owners of the entity, about which concrete data may not be available from the data sources 110. A respective error term may represent unmeasured factors influencing each of the dependent variables—e.g., error term e₁ may represent unmeasured factors influencing or associated with the decisions to implement marketing activities, and error term e₂ may represent unmeasured factors influencing or associated with a particular type of entity result such as entity closing or failure. The model manager 220 may solve the model 182 to determine whether there is a significant correlation between the error terms e₁ and e₂ in the depicted embodiment. If there is a significant correlation, this would indicate that the two dependent variables are related in such a way that it becomes possible to make predictions about the entity result based on the occurrence of the marketing activities (or vice versa, to make predictions about marketing activities based on the entity results). If there is no correlation or very little correlation, it may not be possible to make predictions about either independent variable using the model.

In at least some embodiments, the model manager 220 may evaluate several different sets of independent variables before deciding on a specific model to be used, e.g., based on how well the model's predictions match actual earlier results obtained from the data sources 110. In some embodiments, if a correlation supporting predictions regarding a dependent variable is found using a first modeling approach, a different modeling approach or methodology may be employed by the model manager 220 to confirm that a sufficient correlation exists, and that the correlation was not just an artifact of the first modeling approach or of some kind of error. Any appropriate types of modeling methodology may be used in the depicted embodiment, either for the initial determination of the correlation between the error terms, or for the subsequent validation step, e.g., one methodology may use univariate or bivariate probit modeling, while another uses the seemingly unrelated regression equations (SURE) framework. Thus the model manager 220 may be responsible for generating models, and also for validating the quality of the generated models, in the depicted embodiment. In some implementations, the model manager 220 may support programmatic interfaces allowing a plurality of modeling plug-ins or libraries to be used, with each plug-in or library supporting a respective modeling methodology.

The interface manager 225 may be configured to implement programmatic interfaces, such as web pages, APIs, or GUIs, that can be used by clients 148 to communicate with the predictor 180 (e.g., to submit prediction requests or queries, or to receive generated predictions) in the depicted embodiment. The programmatic interfaces may enable clients to specify formats (e.g., human-readable document formats, machine-readable formats, or both) in which the generated predictions are to be provided in some implementations. In at least one embodiment, the interface manager 225 may also support programmatic interfaces that may be used by one or more data sources 110 to push data to the predictor 180.

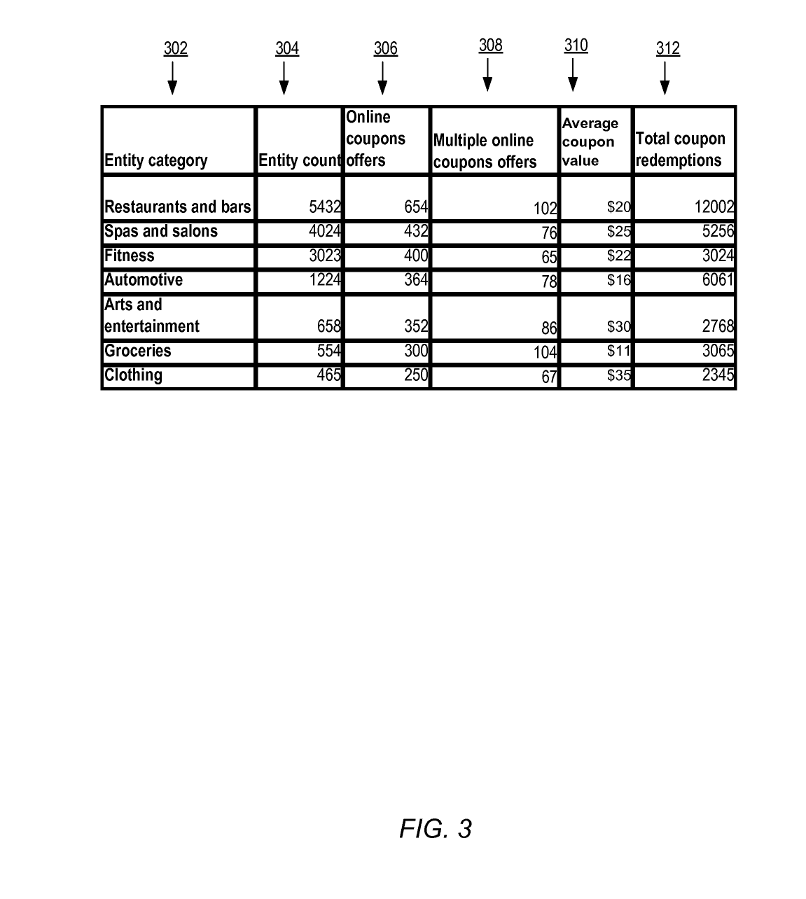

FIG. 3 illustrates examples of predictor-collected data associated with a plurality of entities that have implemented one or more marketing activities, according to at least some embodiments. The example data shown may have been collected from one particular data source 110 (such as online coupon distributor 124), or combined from several of the data sources 110, and may have been organized by the data classifier 215 into the illustrated categories. The data of FIG. 3 may reflect marketing activities associated with offers of online coupons over a particular time period, such as a year. As shown in column 302, the entities represented in the data have been divided into seven categories (“restaurants and bars”, “spas and salons”, “fitness”, “automotive”, “arts and entertainment”, “groceries” and “clothing”) and a number of metrics have been collected for each of the categories. The total number of entities belonging to each category within the collected data set is shown in column 304. The number of entities of each category that implemented online coupons is shown in column 306. The number of entities that offered multiple online coupons—e.g., one coupon each every month for three months—is shown in column 308. The average values of the online coupons for each entity category are shown in column 308. Finally, the total number of coupons redeemed by customers is shown for each category in column 312. In some embodiments, different types of metrics than those shown in FIG. 3 may be collected, even for online coupon-related marketing activities.

Similar information regarding other types of marketing campaigns and activities, such as deferred-payment plans, real or virtual gifts offered to customers that make purchases of at least a threshold price, points in a frequent-buyer program, vendor-specific credit-card offers, and the like may also be collected by predictor 180 in different embodiments. In at least some embodiments, each marketing campaign or activity may have an associated target or goal, and the number of marketing activities that succeeded in meeting their targets may also be collected. The level of details of the metrics collected may depend upon the data source 110, and on the relationship between the predictor 180 and the data source owner. In at least some embodiments, the predictor 180 may collect the types of marketing data indicated above periodically or according to a predefined schedule—e.g., the data may be collected every week or every month.

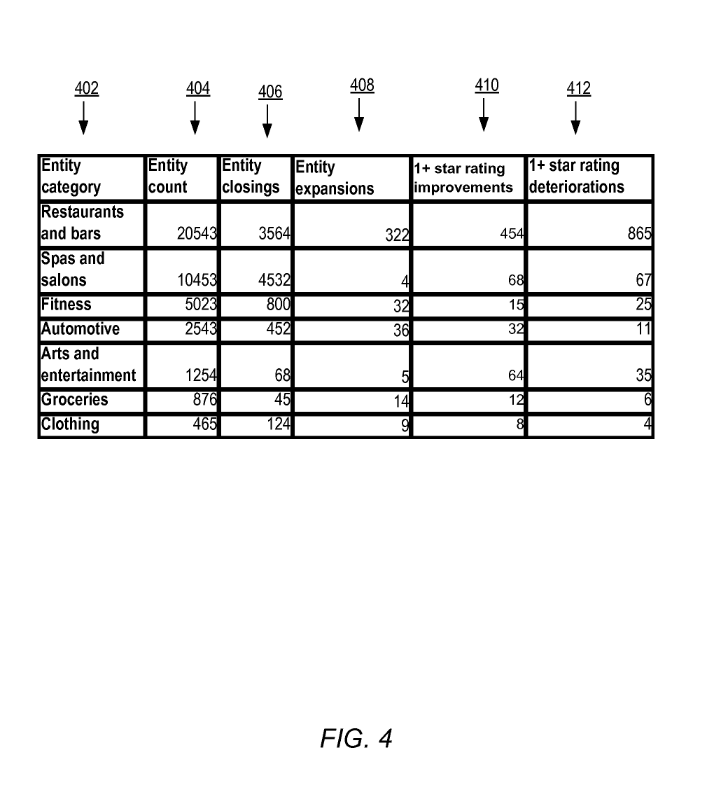

FIG. 4 illustrates examples of predictor-collected data associated with different types of results achieved by a plurality of entities, according to at least some embodiments. Raw data regarding various types of entities and various types of entity results may have been obtained by the predictor from one or more of the data sources 110, and organized by the data classifier 215 as shown in FIG. 4. Once again, the entities covered in the data may be classified into different groups based on the type of their primary product or service, as indicated in column 402. The total number of entities of each category in this set of collected data is shown in column 404.

Measures of several different types of positive and negative results or outcomes are shown in columns 406, 408, 410 and 412 for the depicted embodiment. In column 406, the total number of entity closings (e.g., events in which a particular entity of the category went out of business) is shown. In column 408, counts of positive results, labeled “entity expansions” are shown for each category. The definition of an entity expansion may vary in different embodiments—e.g., in some embodiments the term may refer to a growth of revenue or sales by at least a threshold percentage, while in other embodiments it may refer to a growth in profit, or to a growth in the number of customers, or to a growth in a number of business transactions, or to an increase in the number of physical stores or venues at which the corresponding service or product was available. Corresponding to various types of entity expansions, data on entity contractions may also or instead be collected in some embodiments—e.g., data indicating reduction in revenues, sales, profits, customers, business premises, or transactions. Other types of entity results for which data may be gathered and organized by the predictor may include improvements or deteriorations in customer satisfaction in some embodiments. For example, in column 410, the count of entities in each category whose average customer-generated rating went up by one or more stars, over a scale of one to five stars, is shown. Column 412 shows the count of entities of each category whose customer-ratings worsened by at least one star, over a scale of one to five stars. The star-rating data shown in columns 410 and 412 may have been collected from one or more review/rating services 122 in the depicted embodiment. Other result metrics, such as the number of online searches conducted for a given category of entities, may be obtained in other embodiments. As described above in the context of marketing activity data collections, the predictor 180 may collect various types of entity result periodically or according to a predefined schedule in some embodiments.

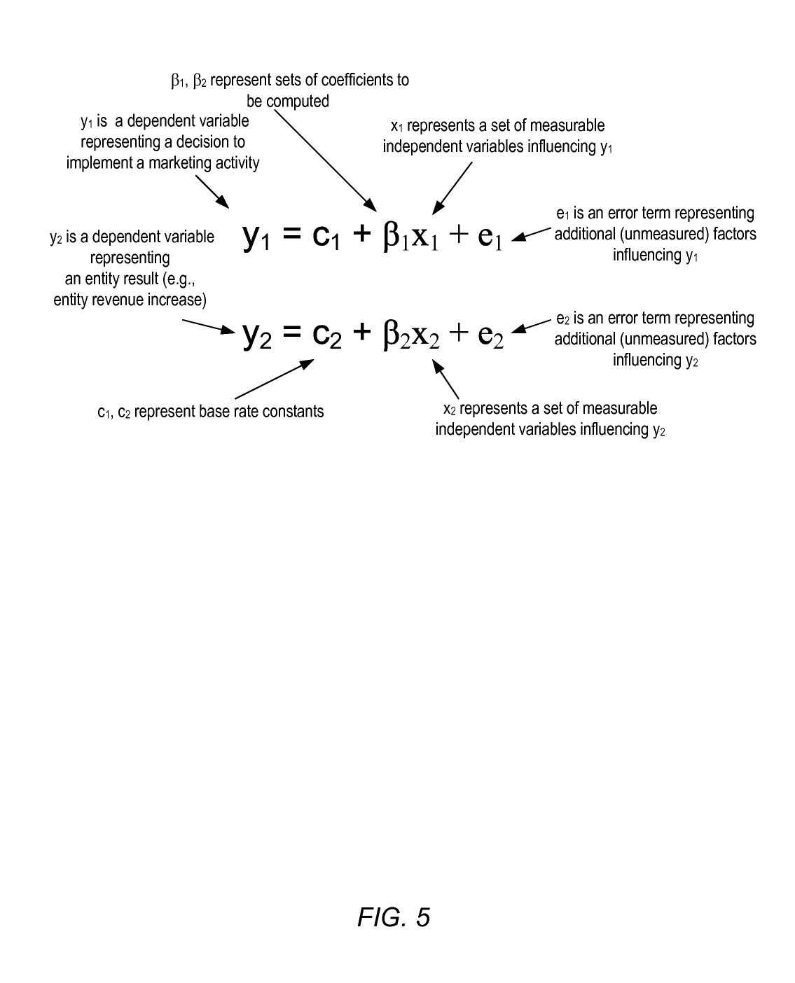

Using the kinds of data shown in FIG. 3 and FIG. 4, predictor 180 may generate one or more models that can be used to provide predictions about some of the types of entity results shown in FIG. 4 in some embodiments. FIG. 5 illustrates an example of the kinds of regression model equations that may be used by the predictor 180 according to at least some embodiments, in which decisions to perform marketing activities are represented by dependent variable y₁, and entity results are represented by dependent variable y₂. In the depicted embodiment, y₁ and y₂ may be binary variables, i.e., each may take either the value “1” or the value “0”. Consider a scenario in which the marketing activity is the implementation of an online coupon offer, and the entity result is a revenue increase by a certain target percentage. If an entity E implements the online coupon offer within a certain time period T, a value of “1” may be assigned to y₁ for that entity E and time period T; otherwise, a value of “0” may be assigned to y₁. If the revenue expands for entity E by the target percentage or more, in some time period T2, y₂ may be assigned the value “1”; otherwise, the value “0” may be assigned to y₂.

In the embodiment illustrated in FIG. 5, each dependent variable yᵢ is shown as being a function of (a) a respective constant base rate cᵢ, (b) a set of independent variables xᵢ with corresponding coefficient sets βᵢ, and (c) an error term eᵢ. The constant c₁ may represent baseline rates of adoption of marketing activities (i.e., a nominal amount that would be expected regardless of any specific business conditions), and c₂ may represent baseline rates of the type of entity result being considered. Either c₁, c₂ or both may be assumed to be zero in some cases, depending on the type of entity result and the type of marketing activity being modeled. The set of independent variables xᵢ may represent such measurable factors, that may be correlated with the independent variables, as the rates at which online coupons are being offered among all entities in the same zip code as entity E, the average star rating achieved by entities of the same category, the number of customer-generated ratings or reviews for entities of the category, the average rating or review for entities of the category, the percentage of all entities whose revenues grew by the target percentage during the time period of interest, and so on. In some cases, at least a subset of the independent variables xᵢ may be common for both the dependent variables. The coefficients δᵢ, representing the relative impact of each of the independent variables being considered, may be evaluated by the predictor 180, e.g., based on the data collected from the various data sources 110 in the depicted embodiment.

The predictor 180 may also determine the extent to which the error terms e₁ and e₂ are related in the depicted embodiment. For example, the covariance of e₁ and e₂, which may be referred to as cov(e₁, e₂) may be determined. If the covariance is a positive value, this may indicate that the two error terms tend to show similar behavior—e.g., as e₁ tends to increase, so does e₁, implying that some of the unmeasured factors influencing the decision to implement the marketing activity also influence the type of entity result being modeled, and that both dependent variables would tend to increase or decrease together. A higher positive covariance value may indicate a stronger relationship between the two sets of unmeasured factors. A negative covariance value may also indicate a relationship between the two sets of unmeasured factors—in this case, a contrarian relationship in which an increase in the marketing activity leads to a decrease in the types of entity results being modeled. If a substantial positive or negative covariance value between the error terms is determined, the occurrences of the marketing activity may be usable to predict the probability of the modeled type of entity result.

For example, consider a simplified scenario in which the constants c₁ and c₂ are zero, and the collected data indicates that the probability of a particular revenue increase at an entity E, based purely on the independent variables assumed to influence the revenue increase, is P1. Consider further that a positive correlation sufficient to increase the probability of the revenue increase by P2 percentage points has been determined, between a decision to implement an online coupon campaign and the revenue increase. Then, if it is determined that an online coupon campaign was in fact implemented by E, a prediction indicating that there is a (P1+P2) percent chance that the E will increase its revenue may be made.

If the covariance between the error terms representing unmeasured factors turns out to be zero (or has a very small absolute value), the impact of unmeasured factors associated with one of the dependent variables on the other dependent variable may not be significant enough to allow useful predictions to be made. It is noted that in some embodiments, equations different from those shown in FIG. 5 may be used by the predictor 180.

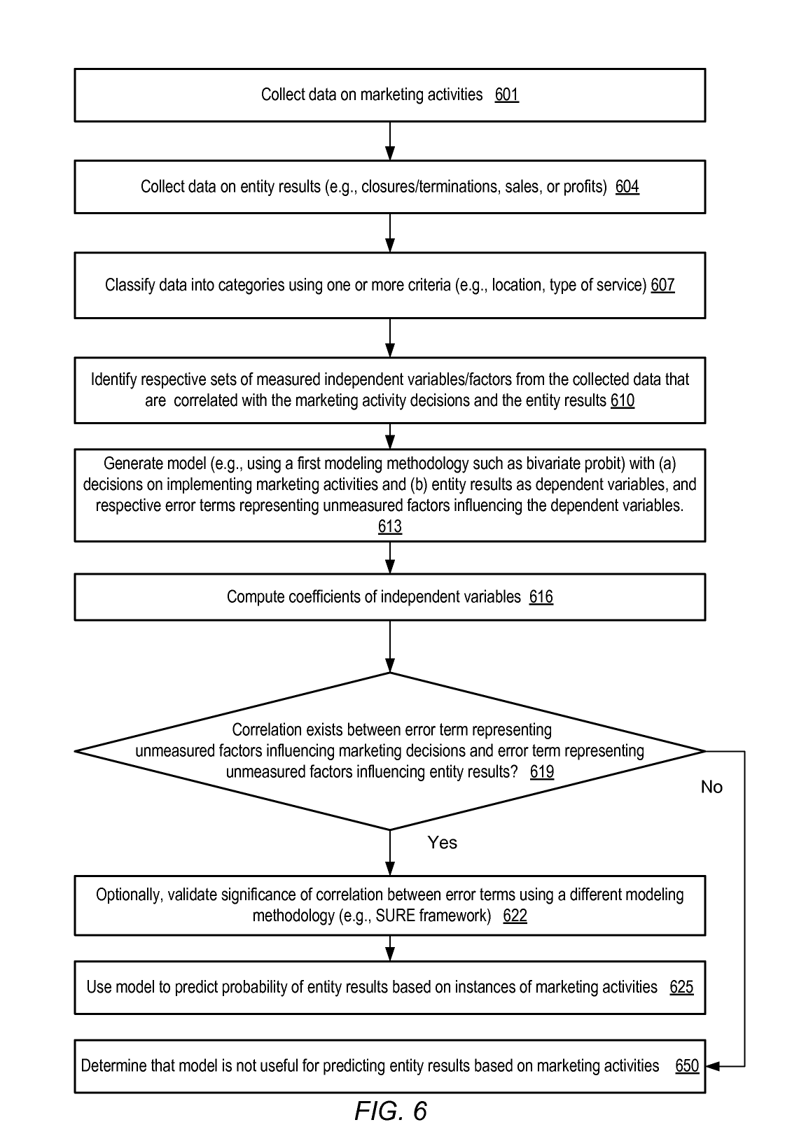

FIG. 6 is a flow diagram illustrating aspects of the operation of a predictor 180 configured to generate entity result predictions using a model, according to at least some embodiments. As shown in element 601, the predictor may collect data on various types of marketing activities (such as the use of online or offline coupons, deferred payment plans, and the like) performed by business entities in the depicted embodiment, e.g., from one or more of the types of data sources 110 shown in FIG. 1. The predictor 180 may also collect data on a number of different types of entity results, such as entity closures, revenue changes, customer satisfaction levels, and the like, as shown in element 604. The collected data may be analyzed and classified into categories based on one or more criteria in the depicted embodiment, as shown in element 607. Classification criteria may include the types of products or services provided, the size (e.g., in revenue or number of employees) of the entity, their geographical locations, the time periods for which the collected data is valid, and so on.

The predictor may identify a set of measured independent variables or factors that are correlated with (and therefore may be assumed to influence) entity results, and another set of measured variables or factors that are correlated with (and therefore may be assumed to influence) marketing activity decisions (i.e., decisions as to whether to implement a particular type of marketing activity, or not to implement the activity) (element 610). As shown in element 613, a model may be generated, e.g., using a first modeling methodology, in which entity results and the decisions to implement a particular marketing activity are each represented by respective dependent variables. The model may include terms representing the independent variables (each with a respective coefficient indicative of the relative impact of that independent variable) correlated with the dependent variables, as well as respective error terms representing unmeasured factors. Thus, for example, a first error term may be included in an equation for a dependent variable representing the marketing activity decision, representing unmeasured factors influencing the marketing activity decisions; and a second error term may be included in an equation for a dependent variable representing a type of entity result, representing unmeasured factors influencing the entity results.

In the depicted embodiment, the predictor may compute the coefficients of the various independent variables (element 616), thus determining the relative impacts of the measured factors on the corresponding dependent variable. The predictor may also determine whether a statistically significant correlation exists between the error terms associated with the two independent variables (element 619), e.g., by computing the covariance between the two error terms, or by computing correlation indicators other than covariance. If no significant correlation is found, the predictor may determine that the model is not useful for predicting entity results based on the occurrence of marketing activities (element 650). If a significant correlation is found, the predictor may optionally use a second modeling methodology to validate the correlation (element 622). The predictor may generate predictions regarding the probability of a particular type of entity result, based on the occurrence of the marketing activity being modeled (element 625). In some embodiments, predictions of marketing activities may be generated using the model, based on entity results—i.e., the predictions regarding either dependent variable may be made based on the occurrence of events represented by the other dependent variable.

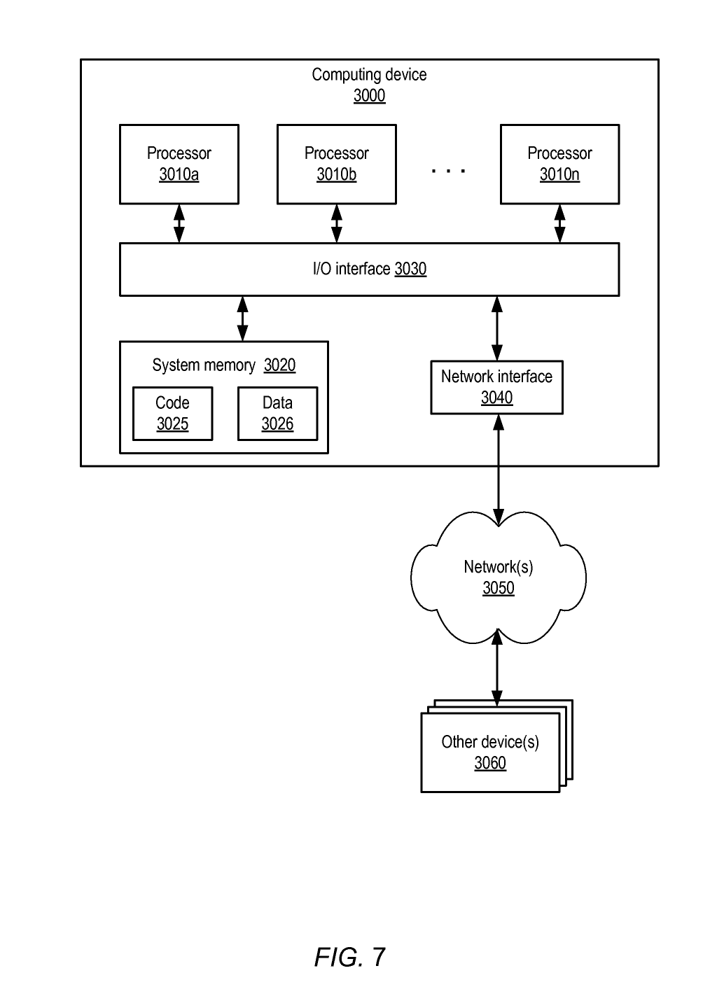

FIG. 7 illustrates an example computing device 3000 that may be used in some embodiments to implement at least some of the functionality of the predictor 180. In the illustrated embodiment, computing device 3000 includes one or more processors 3010 coupled to a system memory 3020 via an input/output (I/O) interface 3030. Computing device 3000 further includes a network interface 3040 coupled to I/O interface 3030.

In various embodiments, computing device 3000 may be a uniprocessor system including one processor 3010, or a multiprocessor system including several processors 3010 (e.g., two, four, eight, or another suitable number). Processors 3010 may be any suitable processors capable of executing instructions. For example, in various embodiments, processors 3010 may be general-purpose or embedded processors implementing any of a variety of instruction set architectures (ISAs), such as the x86, PowerPC, SPARC, or MIPS ISAs, or any other suitable ISA. In multiprocessor systems, each of processors 3010 may commonly, but not necessarily, implement the same ISA.

System memory 3020 may be configured to store instructions and data accessible by processor(s) 3010. In various embodiments, system memory 3020 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing one or more desired functions, such as those methods, techniques, and data described above, are shown stored within system memory 3020 as code 3025 and data 3026.

In one embodiment, I/O interface 3030 may be configured to coordinate I/O traffic between processor 3010, system memory 3020, and any peripheral devices in the device, including network interface 3040 or other peripheral interfaces. In some embodiments, I/O interface 3030 may perform any necessary protocol, timing or other data transformations to convert data signals from one component (e.g., system memory 3020) into a format suitable for use by another component (e.g., processor 3010). In some embodiments, I/O interface 3030 may include support for devices attached through various types of peripheral buses, such as a variant of the Peripheral Component Interconnect (PCI) bus standard or the Universal Serial Bus (USB) standard, for example. In some embodiments, the function of I/O interface 3030 may be split into two or more separate components, such as a north bridge and a south bridge, for example. Also, in some embodiments some or all of the functionality of I/O interface 3030, such as an interface to system memory 3020, may be incorporated directly into processor 3010.

Network interface 3040 may be configured to allow data to be exchanged between computing device 3000 and other devices 3060 attached to a network or networks 3050, such as other computer systems or devices as illustrated in FIG. 1 through FIG. 6, for example. In various embodiments, network interface 3040 may support communication via any suitable wired or wireless general data networks, such as types of Ethernet network, for example. Additionally, network interface 3040 may support communication via telecommunications/telephony networks such as analog voice networks or digital fiber communications networks, via storage area networks such as Fibre Channel SANs, or via any other suitable type of network and/or protocol.

In some embodiments, system memory 3020 may be one embodiment of a computer-accessible medium configured to store program instructions and data as described above for FIG. 1 through FIG. 6 for implementing embodiments of the corresponding methods and apparatus. However, in other embodiments, program instructions and/or data may be received, sent or stored upon different types of computer-accessible media. Generally speaking, a computer-accessible medium may include non-transitory storage media or memory media such as magnetic or optical media, e.g., disk or DVD/CD coupled to computing device 3000 via I/O interface 3030. A non-transitory computer-accessible storage medium may also include any volatile or non-volatile media such as RAM (e.g. SDRAM, DDR SDRAM, RDRAM, SRAM, etc.), ROM, etc, that may be included in some embodiments of computing device 3000 as system memory 3020 or another type of memory. Further, a computer-accessible medium may include transmission media or signals such as electrical, electromagnetic, or digital signals, conveyed via a communication medium such as a network and/or a wireless link, such as may be implemented via network interface 3040. Portions or all of multiple computing devices such as that illustrated in FIG. 7 may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computing device”, as used herein, refers to at least all these types of devices, and is not limited to these types of devices.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent example embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

1. A method, comprising:
performing, by one or more computing devices:
determining, based at least in part on data collected over a time period, a first set of measurable factors with which decisions to implement a type of marketing activity are correlated, and a second set of measurable factors with which a category of entity results is correlated;
generating, using at least in part the first and second sets of measurable factors, a model configured to predict a respective probability of one or more results of the category of entity results, the model including a first set of one or more unmeasured factors influencing the category of entity results and a second set of one or more unmeasured factors influencing decisions on implementing the type of marketing activity;
determining a correlation between the first set of one or more unmeasured factors and the second set of one or more unmeasured factors; and
when the correlation is statistically significant, predicting, using the model, the probability of a particular result of the category of entity results for a particular entity.

2. The method as recited in claim 1, wherein the category of entity results comprises at least one of: (a) entity closure, (b) sales, (c) profits, (d) a number of customers, or (e) a number of business transactions performed.

3. The method as recited in claim 1, wherein at least one set of the first and second sets of measurable factors includes a factor based on at least one of: (a) a category of product or service provided, (b) a location, (c) a range of annual revenues, (d) a number of employees, (e) a customer satisfaction rating, or (f) a number of feedback entries generated by clients.

4. The method as recited in claim 1, wherein the type of marketing activity comprises an offer of at least one of: (a) an online coupon, (b) an offline coupon, (c) a deferred-payment plan, or (d) a gift for purchasing a particular product or service.

5. The method as recited in claim 1, wherein the model comprises a regression model that includes, as respective dependent variables (a) an occurrence of a particular result of the category of entity results, and (b) an implementation of a marketing activity of the type of marketing activity.

6. The method as recited in claim 1, wherein said generating the model comprises utilizing an equation in which an error term represents at least one of: (a) the one or more unmeasured factors represented in the model as influencing the category of entity results, or (b) the one or more unmeasured factors represented in the model as influencing decisions on implementing the type of marketing activity.

7. The method as recited in claim 1, wherein said generating the model comprises:
determining, using a first modeling methodology, the correlation between the one or more unmeasured factors represented in the model as influencing the category of entity results and the one or more unmeasured factors represented in the model as influencing decisions on implementing the type of marketing activity, and
verifying that the correlation is statistically significant, based at least in part on using a second modeling methodology.

8. The method as recited in claim 7, wherein a modeling methodology of the first and second modeling methodologies comprises a use of one of: (a) a probit model or (b) a seemingly unrelated regression equations (SURE) model.

9. The method as recited in claim 1, further comprising:
collecting data programmatically from at least one of (a) an entity database implemented by a government agency (b) an entity rating web site (c) an entity providing a platform for implementation of the type of marketing activities or (d) an aggregator of marketing promotions; and
determining the first and second sets of measurable factors based at least in part on the collected data.

10. A system, comprising:
one or more processors; and
a memory comprising program instructions executable by the one or more processors to:
determine a first set of measurable factors with which decisions to implement a type of marketing activity are correlated, and a second set of measurable factors with which a category of entity results is correlated;
generate, using at least in part the first and second sets of measurable factors, a model configured to predict a respective probability of one or more results of the category of entity results, the model including a first set of one or more unmeasured factors influencing the category of entity results and a second set of one or more unmeasured factors influencing decisions on implementing the type of marketing activity;
determine a correlation between the first set of one or more unmeasured factors and the second set of one or more unmeasured factors; and
when the correlation is statistically significant, predict, using the model, the probability of a particular result of the category of results for a particular entity.

11. The system as recited in claim 10, wherein the category of entity results comprises at least one of: (a) entity termination, (b) sales, (c) profits, (d) a number of customers, or (e) a number of business transactions performed.

12. The system as recited in claim 10, wherein at least one set of the first and second sets of measurable factors includes a factor based on at least one of: (a) a category of product or service provided, (b) a location, (c) a range of annual revenues, (d) a number of employees, (e) a customer satisfaction rating, or (f) a number of feedback entries generated by clients.

13. The system as recited in claim 10, wherein the type of marketing activity comprises an offer of at least one of: (a) an online discount coupon, (b) an offline discount coupon, (c) a deferred-payment plan, or (d) a gift for purchasing a particular product or service.

14. The system as recited in claim 10, wherein the model comprises a regression model that includes, as respective dependent variables, (a) an occurrence of a particular result of the category of entity results, and (b) an implementation of a marketing activity of the type of marketing activity.

15. The system as recited in claim 10, wherein to generate the model, the instructions when executed on the one or more processors utilize an equation in which an error term represents at least one of: (a) the one or more unmeasured factors represented in the model as influencing the category of entity results, or (b) the one or more unmeasured factors represented in the model as influencing decisions on implementing the type of marketing activity.

16. A non-transitory computer-readable storage medium storing program instructions that when executed by a computing device implement:
determining a first set of measurable factors with which decisions to implement a type of marketing activity are correlated, and a second set of measurable factors with which a category of entity results is correlated;
generating, using at least in part the first and second sets of measurable factors, a model configured to predict a respective probability of one or more results of the category of entity results, the model including a first set of one or more unmeasured factors influencing the category of entity results and a second set of one or more unmeasured factors influencing decisions on implementing the type of marketing activity;
determining a correlation between the first set of one or more unmeasured factors and the second set of one or more unmeasured factors; and
when the correlation is statistically significant, predicting, using the model, the probability of a particular result of the category of results for a particular entity.

17. The non-transitory computer-readable storage medium as recited in claim 16, wherein the model comprises a regression model that includes, as a dependent variable, at least one of (a) an occurrence of a particular result of the category of entity results, or (b) an implementation of a marketing activity of the type of marketing activity.

18. The non-transitory computer-readable storage medium as recited in claim 16, wherein said generating the model comprises utilizing an equation in which an error term represents at least one of: (a) the one or more unmeasured factors represented in the model as influencing the category of entity results, or (b) the one or more unmeasured factors represented in the model as influencing decisions on implementing the type of marketing activity.

19. The non-transitory computer-readable storage medium as recited in claim 16, wherein said generating the model comprises:
determining, using a first modeling methodology, a correlation between the one or more unmeasured factors represented in the model as influencing the category of entity results, and the one or more unmeasured factors represented in the model as influencing decisions on implementing the type of marketing activity, and
verifying that the correlation is statistically significant, based at least in part on using a second modeling methodology.

20. The non-transitory computer-readable storage medium as recited in claim 19, wherein a modeling methodology of the first and second modeling methodologies comprises a use of one of: (a) a probit model or (b) a seemingly unrelated regression equations (SURE) model.
